(19) United States
(12) Patent Application Publication
(10) Pub. No.: US 2021/0371309 A1
(43) Pub. Date: Dec. 2, 2021

(54) Ornamental Chlorine Float Assembly

(71) Applicant: Brandon Gallant, Papillion, NE (US)

(72) Inventor: Brandon Gallant, Papillion, NE (US)

(21) Appl. No.: 16/886,167

(22) Filed: May 28, 2020

(51) Int. Cl. C02F 1/76; C02F 1/68; H04R 1/02; F21V 33/00; F21L 4/08

(52) U.S. Cl. CPC C02F 1/76; C02F 1/685; H04R 1/028; C02F 2103/42; F21V 33/004; F21L 4/08; F21V 33/0056

(57) ABSTRACT

An ornamental chlorine float assembly for chlorinating a swimming pool includes a chlorine float that is floatable in a swimming pool. The chlorine float is structured to have a variety of pre-determined ornamental features to enhance visual appeal of the chlorine float when the chlorine float is floating in the swimming pool. A plurality of light emitters is each of the light emitters is coupled to the bottom side of the chlorine float to illuminate the water in the swimming pool. A plurality of speakers is each coupled to the top side of the chlorine float to emit sound outwardly therefrom.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to chlorine float devices and more particularly pertains to a new chlorine float device for chlorinating water in a swimming pool.

### (2) Description of Related Art including Information Disclosed Under 37 CFR 1.97 and 1.98.

The prior art relates to chlorine float devices. The prior art discloses a chlorine float that is structured to resemble a sail boat. The prior art discloses a floating platform that includes a signal repeater for placing a plurality of personal electronic devices in communication with the floating platform. The prior art discloses a variety of floating speakers that receive an audio signal from a transmission source. The prior art discloses a chlorinating ball for containing chlorine tablets. The prior art also discloses a chlorine float that is shaped like an animal.

### BRIEF SUMMARY OF THE INVENTION

An embodiment of the disclosure meets the needs presented above by generally comprising a chlorine float that is floatable in a swimming pool. The chlorine float is structured to have a variety of pre-determined ornamental features to enhance visual appeal of the chlorine float when the chlorine float is floating in the swimming pool. A plurality of light emitters is each of the light emitters is coupled to the bottom side of the chlorine float to illuminate the water in the swimming pool. A plurality of speakers is each coupled to the top side of the chlorine float to emit sound outwardly therefrom.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an ornamental chlorine float assembly according to an embodiment of the disclosure.

FIG. 2 is a bottom view of an embodiment of the disclosure.

FIG. 3 is a left side view of an embodiment of the disclosure.

FIG. 4 is a front phantom view of an embodiment of the disclosure.

FIG. 5 is a back view of an embodiment of the disclosure.

### DETAILED DESCRIPTION OF THE INVENTION

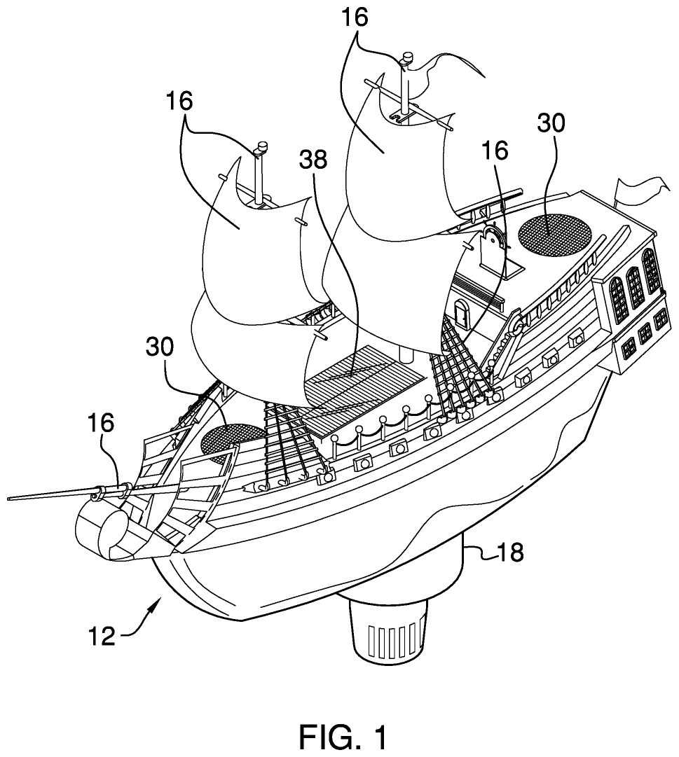

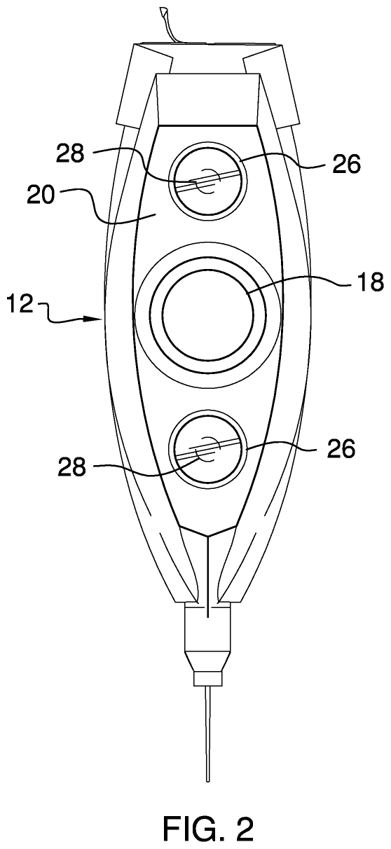

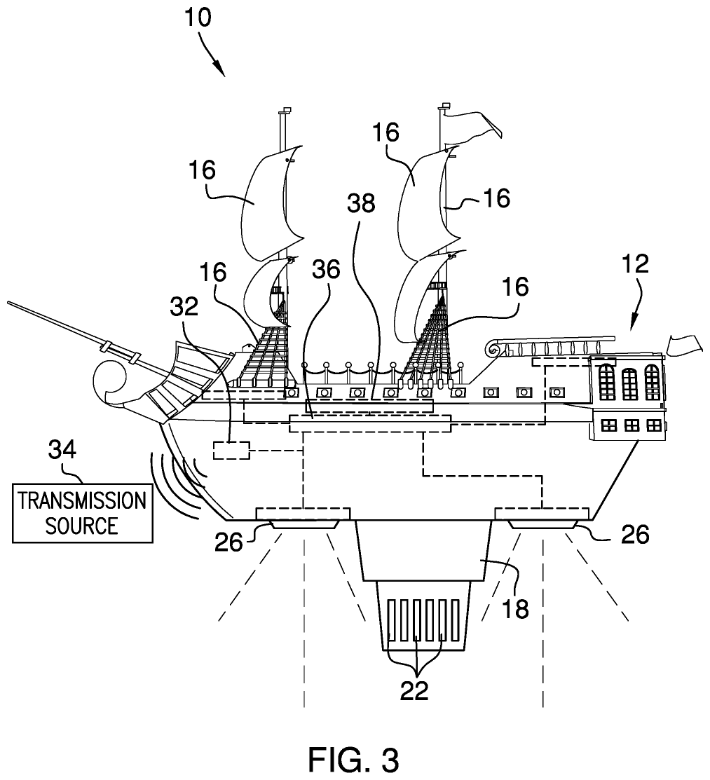

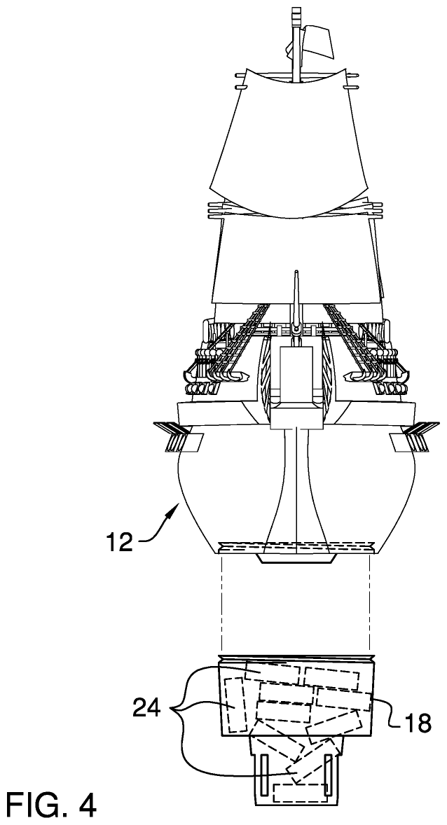

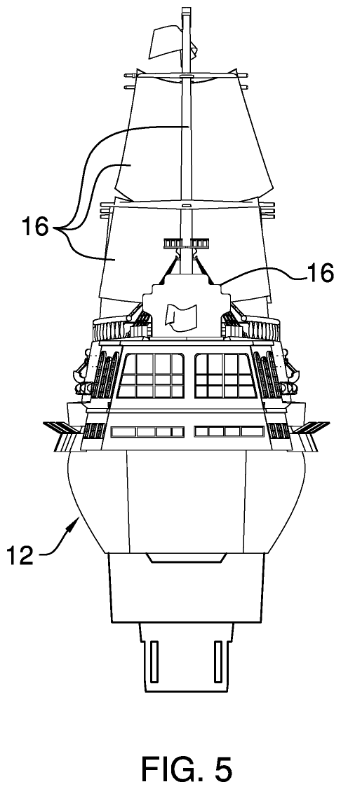

With reference now to the drawings, and in particular to FIGS. 1 through 5 thereof, a new chlorine float device embodying the principles and concepts of an embodiment of the disclosure and generally designated by the reference numeral 10 will be described.

As best illustrated in FIGS. 1 through 5, the ornamental chlorine float assembly 10 generally comprises a chlorine float 12 that is floatable in a swimming pool such that the chlorine float 12 is in fluid communication with water in the swimming pool. The chlorine float 12 has a top side 14 and the top side 14 is structured to have a variety of pre-determined ornamental features 16 to enhance visual appeal of the chlorine float 12 when the chlorine float 12 is floating in the swimming pool. The chlorine float 12 includes an intake 18 extending downwardly from a bottom side 20 of the chlorine float 12 to facilitate the intake 18 to be submerged. The intake 18 is hollow and the intake 18 has a plurality of water inlets 22 each extending into an interior of the intake 18 for passing water into the intake 18. The intake 18 is removable from the chlorine float 12 and the chlorine tablets 24 are positionable therein for chlorinating the water in the swimming pool. As is most clearly shown in FIGS. 1, 3, 4 and 5, the pre-determined ornamental features 16 may include, but not be limited to, masts, sails, flags and rigging commonly associated with maritime vessels. Additionally, the ornamental features 16 may include identifying structural details of a variety of different objects.

A plurality of light emitters 26 is each coupled to the bottom side 20 of the chlorine float 12 to illuminate the water in the swimming pool. Each of the light emitters 26 may comprise an LED or the like and each of the light emitters 26 has a hermetically sealed lens 28 to protect the light emitters 26 from water. A plurality of speakers 30 is each coupled to the top side 14 of the chlorine float 12 to emit sound outwardly therefrom. Each of the speakers 30 may comprise water resistant speakers 30 commonly found on outdoor audio devices. A light sensor may be attached to the chlorine float 12, and be in electrical communication with the light emitters 26, for sensing a minimum intensity of ambient light and subsequently turning on the light emitters 26.

A receiver 32 is provided, the receiver 32 is coupled to the chlorine float 12 and the receiver 32 is electrically coupled to the speakers 30. The receiver 32 is in wireless communication with a transmission source 34 to communicate an audio signal to the speakers 30. The receiver 32 may comprise a radio frequency receiver or the like and the receiver 32 may employ Bluetooth communication protocols.

A power supply 36 is provided and the power supply 36 is coupled to the chlorine float 12. The power supply 36 is electrically coupled to the receiver 32, each of the speakers 30 and each of the light emitters 26. The power supply 36 comprises at least one battery 38 that is positioned in the chlorine float 12. The at least one battery 38 is electrically coupled to the receiver 32, each of the speakers 30 and each of the light emitters 26. The power supply 36 comprises a solar panel 38 that is coupled to the top side 14 of the chlorine float 12 to be exposed to sunlight. The solar panel 38 is electrically coupled to the at least one battery 38 for charging the at least one battery 38.

In use, the chlorine tablets 24 are placed in the intake 18 and the chlorine float 12 is floated into the water in the swimming pool for chlorinating the water in the swimming pool. The receiver 32 can be synched with the transmission source 34, such as a Bluetooth audio transmitter or the like, thereby facilitating the speakers 30 to emit audio for the listening pleasure of users. Additionally, the light emitters 26 emit light into the water to create a visually appealing display beneath the chlorine float 12. The chlorine tablets 24 are replaced as necessary to keep the water at a desired level of chlorination.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. An ornamental chlorine float assembly being configured to release chlorine into a swimming pool, said assembly comprising:
a chlorine float being floatable in a swimming pool wherein said chlorine float is configured to be in fluid communication with water in the swimming pool, said chlorine float having a top side, said top side being structured to have a variety of pre-determined ornamental features wherein said top side is configured to enhance visual appeal of said chlorine float when said chlorine float is floating in the swimming pool, said chlorine float containing chlorine wherein said chlorine float is configured to chlorinate the water in the swimming pool;
a plurality of light emitters, each of said light emitters being coupled to said bottom side of said chlorine float wherein each of said light emitters is configured to illuminate the water in the swimming pool; and
a plurality of speakers, each of speakers being coupled to said top side of said chlorine float wherein each of said speakers is configured to emit sound outwardly therefrom.

2. The assembly according to claim 1, wherein said chlorine float includes an intake extending downwardly from a bottom side of said chlorine float wherein said intake is configured to be submerged, said intake being hollow, said intake having a plurality of water inlets each extending into an interior of said intake wherein said plurality of water inlets is configured to pass water into said intake, said intake being removable from said chlorine float, said intake having chlorine tablets being positioned therein wherein said intake is configured to chlorinate the water in the swimming pool.

3. The assembly according to claim 1, further comprising a receiver being coupled to said chlorine float, said receiver being electrically coupled to said speakers, said receiver being in wireless communication with a transmission source wherein said receiver is configured to communicate an audio signal to said speakers.

4. The assembly according to claim 3, further comprising a power supply being coupled to said chlorine float, said power supply being electrically coupled to said receiver, each of said speakers and each of said light emitters, said power supply comprising:
at least one battery being positioned in said chlorine float, said at least one battery being electrically coupled to said receiver, each of said speakers and each of said light emitters; and
a solar panel being coupled to said top side of said chlorine float wherein said solar panel is configured to be exposed to sunlight, said solar panel being electrically coupled to said at least one battery for charging said at least one battery.

5. An ornamental chlorine float assembly being configured to release chlorine into a swimming pool, said assembly comprising:
a chlorine float being floatable in a swimming pool wherein said chlorine float is configured to be in fluid communication with water in the swimming pool, said chlorine float having a top side, said top side being structured to have a variety of pre-determined ornamental features wherein said top side is configured to enhance visual appeal of said chlorine float when said chlorine float is floating in the swimming pool, said chlorine float including an intake extending downwardly from a bottom side of said chlorine float wherein said intake is configured to be submerged, said intake being hollow, said intake having a plurality of water inlets each extending into an interior of said intake wherein said plurality of water inlets is configured to pass water into said intake, said intake being removable from said chlorine float, said intake having chlorine tablets being positioned therein wherein said intake is configured to chlorinate the water in the swimming pool;
a plurality of light emitters, each of said light emitters being coupled to said bottom side of said chlorine float wherein each of said light emitters is configured to illuminate the water in the swimming pool;
a plurality of speakers, each of speakers being coupled to said top side of said chlorine float wherein each of said speakers is configured to emit sound outwardly therefrom;
a receiver being coupled to said chlorine float, said receiver being electrically coupled to said speakers, said receiver being in wireless communication with a transmission source wherein said receiver is configured to communicate an audio signal to said speakers; and
a power supply being coupled to said chlorine float, said power supply being electrically coupled to said receiver, each of said speakers and each of said light emitters, said power supply comprising:
at least one battery being positioned in said chlorine float, said at least one battery being electrically coupled to said receiver, each of said speakers and each of said light emitters; and
a solar panel being coupled to said top side of said chlorine float wherein said solar panel is configured to be exposed to sunlight, said solar panel being electrically coupled to said at least one battery for charging said at least one battery.
